(19) United States
(12) Patent Application Publication
(10) Pub. No.: US 2005/0062585 A1
(43) Pub. Date: Mar. 24, 2005

(54) Resistor and electronic device

(75) Inventors: Hirobumi Tanaka, Chuo-ku (JP); Katsuhiko Igarashi, Chuo-ku (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 10/944,193

(22) Filed: Sep. 20, 2004

(30) Foreign Application Priority Data
Sep. 22, 2003 (JP) 2003-329968

(51) Int. Cl. H01C 1/012

(52) U.S. Cl. 338/308

(57) ABSTRACT

A resistor having a resistor layer on a substrate, obtained by forming on the substrate a resistor paste including a glass material substantially not containing lead but containing CaO and B₂O₃, a conductive material substantially not containing lead, and an organic vehicle, then, firing at a temperature of 830 to 870° C. for 5 to 15 minutes; wherein, when observing a section along the thickness direction of the resistor layer with a transmission electron microscope (TEM), an occupying area of a crystal substance CaB₂O₄ precipitated in the resistor layer of the observation section is less than 30.0% of an area of the resistor layer of said observation section. According to the invention, it is possible to provide a lead-free resistor having a high resistance value and a short time overload (STOL).

### BACKGROUND OF THE INVENTION

1. Field of the Invention

The present invention relates to a resistor and an electronic device.

2. Description of the Related Art

Generally, a resistor paste is mainly constituted of a glass material for adjusting a resistance value and giving a bonding property, a conductive material and an organic vehicle (a binder and a solvent). By printing the paste on a substrate and firing, a resistor having a film thickness of 5 to 25 μm or so is formed.

Many of resistor pastes of the related art use lead oxide based glass as a glass material, and a ruthenium oxide or a compound of ruthenium oxide and lead as a conductive material, so that the pastes include lead.

However, use of a resistor paste containing lead is unfavorable in terms of environment contamination, so that there are a variety of proposals made on a lead-free thick resistor paste (refer to patent articles 1 to 5).

Normally, A resistor having a sheet resistance value of 10 kΩ/□ or more uses Pb₂Ru₂O₅ having a high resistivity as a conductive material. Thus, it has been relatively easy to attain high resistance.

When considering the environment as above, however, not to mention PbO based glasses, it is preferable to prevent using Pb₂Ru₂O₅ as a conductive material. As conductive materials having a comparable resistivity as that of Pb₂Ru₂O₅; BaRuO₃, CaRuO₃, SrRuO₃ and Bi₂Ru₂O₇, etc. may be mentioned. But when forming a resistor with these conductive materials and glass not containing lead, particularly deterioration of short time overload (STOL) as one of voltage resistance characteristics became a problem in a resistor having a resistance value of 100 kΩ/□ or more and it was difficult to adjust the characteristics.

As a reason of the difficulty, there is the fact that knowledge of suppressing STOL has not been obtained because history of studying a thick membrane resistor not containing lead is short comparing with a thick membrane resistor containing lead.

Patent Article 1: The Japanese Unexamined Patent Publication No. 8-253342

Patent Article 2: The Japanese Unexamined Patent Publication No. 10-224004

Patent Article 3: The Japanese Unexamined Patent Publication No. 2001-196201

Patent Article 4: The Japanese Unexamined Patent Publication No. 11-251105

Patent Article 5: The Japanese Patent No. 3019136

### SUMMARY OF THE INVENTION

An object of the present invention is to provide a lead-free resistor having a high resistance value and small short time overload (STOL), and an electronic device, such as a circuit substrate having the resistor.

To attain the above object, according to the present invention, there is provided a resistor, having a resistor layer including a glass material substantially not containing lead but containing CaO and B₂O₃ and a conductive material substantially not containing lead, wherein:
when observing a section along the thickness direction of said resistor layer with a transmission electron microscope (TEM), an occupying area of a crystal substance CaB₂O₄ precipitated in a resistor layer of said observation section is less than 30.0% (preferably 28.0% or less) of the resistor layer of said observation section.

The present inventors have found when performing TEM observation on the section in a thickness direction of a resistor layer formed on a substrate that a lead-free resistor having a high resistance value and a small STOL was able to be provided in the case where an occupying area of crystalline substances precipitated in a resistor layer of the observation section was less than 30.0% of an area of the resistor layer of the observation section.

A resistor of the present invention is preferably obtained by forming a resistor paste including a glass material substantially not containing lead but containing CaO and B₂03, a conductive material substantially not containing lead, and an organic vehicle, then, firing at 830 to 870° C. for 5 to 15 minutes.

Preferably, said glass material includes an A group containing CaO, a B group containing B₂O₃, and a C group containing SiO₂; and contents of the respective groups are A group: 25 to 40 mol %, B group: 20 to 40 mol %, and C group: 20 to 40 mol %.

Preferably, said glass material includes an A group containing CaO, a B group containing B₂O₃, a C group containing SiO₂, a D group containing at least one kind of ZrO₂, SrO and CuO, and an E group containing NiO; and contents of the respective groups are A group: 25 to 40 mol %, B group: 20 to 40 mol %, C group: 20 to 40 mol %, D group: 0 to 10 mol % (excluding 0 mol %), and E group: 0.1 to 10 mol %.

Preferably, said conductive material contains at least one selected from BaRuO₃, SrRuO₃, RuO₂ and CaRuO₃.

Preferably, said resistor layer includes 65 to 93 volume % of said glass material and 7 to 35 volume % of said conductive material.

According to the present invention, there is provided an electronic device having any one of the above resistors.

In the present invention, the expression “substantially not containing lead” means lead is not included by an amount of exceeding an impurity level, and lead may be contained by an amount of an impurity level (for example, a content in a glass material or a conductive material is 0.05 volume % or less). A trace of lead may be sometimes included as an inevitable impurity.

### EFFECT OF THE INVENTION

According to the present invention, a lead-free resistor having a high resistance value (for example, 100 kΩ/□ or more, and preferably 1 MΩ/□ Or more) and small STOL (for example, less than ±7%, and preferably less than ±5%) can be provided. Namely, a resistor of the present invention is highly useful due to the capability of maintaining preferable characteristics even when a temperature and an application voltage in the use environment change.

### BRIEF DESCRIPTION OF DRAWINGS

These and other objects and features of the present invention will become clearer from the following description of the preferred embodiments given with reference to the attached drawings, in which:

FIG. 1 is a TEM picture of a section of a resistor (sample 14) in an embodiment; and

FIG. 2 is a TEM picture of a section of a resistor (sample 29) in an embodiment.

### DESCRIPTION OF THE PREFERRED EMBODIMENT

Resistor

A resistor according to the present invention has a resistor layer on a substrate. Also, when observing a section along the thickness direction of the resistor layer with a transmission electron microscope (TEM), a resistor according to the present invention has an occupying area of a crystal substance CaB₂O₄ precipitated in the resistor layer of the observation section is less than 30.0%, preferably 28.0% or less, and more preferably 15.0% or less of an area of the resistor layer of the observation section.

The present inventors found that the smaller an occupying area of a crystal substance CaB₂O₄, the smaller the STOL can be suppressed while maintaining a high resistance value. On the other hand, in the case where the occupying area of the crystal substance CaB₂O₄ is too small, when a glass material containing ZrO₂ is used, the ZrO₂ precipitates, consequently, it may cause deterioration of the STOL. Therefore, the lower limit of the occupying area of the crystal substance CaB₂O₄ is preferably 5% or so.

Substrate

As the substrate, for example, alumina, glass ceramics, dielectric and AIN, etc. may be mentioned.

Resistor Layer

The resistor layer includes a glass material substantially not containing lead but containing CaO and B₂O₃ and a conductive material substantially not containing lead.

The glass material substantially not containing lead but containing CaO and B₂O₃ is not particularly limited, but it preferably includes
an A group containing CaO,
a B group containing B₂O₃ and
a C group containing SiO₂.

More preferably, those containing Cao, B₂O₃ and SiO₂ are used as the glass material.

A content of each group is preferably
A group: 25 to 40 mol %,
B group: 20 to 40 mol %, and
C group: 20 to 40 mol %;
   and more preferably,
A group: 29 to 38 mol %,
B group: 22 to 36 mol %, and
C group: 24 to 40 mol %;

The glass material may further contains a D group containing at least one kind selected from ZrO₂, SrO, CuO, ZnO, MnO, CoO, Li₂O, Na₂O, K₂O, P₂O₅, TiO₂, Bi₂O₃, V₂O₅ and Fe₂O₃ (preferably, at least one kind of ZrO₂, SrO and CuO) in addition to the above A to C groups. Preferably, those containing CaO, B₂O₃, SiO₂ and ZrO₂ are used as the glass material.

A content of the D group in this case is preferably 0 to 10 mol % (excepting 0 mol %), and more preferably 0 to 7 mol % (excepting 0 mol %).

Preferably, the glass material further includes an E group containing NiO in addition to the above A to D groups. More preferably, those containing CaO, B₂O₃, SiO₂, ZrO₂ and NiO are used as the glass material.

As a result that the E group containing NiO is included in the glass material, an occupying area of the crystal substance CaB₂O₄ precipitated in the resistor layer can be suppressed, the TCR and STOL of a resistor to be obtained are balanced, and a change over time is effectively suppressed.

A content of the E group in this case is preferably 0.1 mol % or more, more preferably 1 mol % or more and further preferably 2 mol % or more; and preferably 10 mol % or less and more preferably 6 mol % or less.

A conductive material substantially not containing lead is not particularly limited, and a ruthenium oxide, an Ag—Pd alloy, TaN, LaB₆, WC, MoSiO₂, TaSiO₂ and metal (Ag, Au, Pd, Pt, Cu, Ni, W and Mo, etc.), etc. may be mentioned. These substances may be used alone or in combination of two or more kinds. Among these, a ruthenium oxide is preferable.

As the ruthenium oxide, ruthenium oxides (RuO₂, RuO₃ and RuO₄), ruthenium based pyrochlore (Bi₂Ru₂O₇₋ₓ and Tl₂Ru₂O₇, etc.) and ruthenium composite oxides (SrRuO₃, CaRuO₃ and BaRuO₃, etc.), etc. are included. Among these, ruthenium oxides and ruthenium composite oxides are preferable, and RuO₂, SrRuO₃, CaRuO₃ and BaRuO₃, etc. are more preferable.

Contents of the glass material and conductive material in the resistor layer are, the glass material of preferably 65 to 93 volume % and more preferably 68 to 90 volume %; and the conductive material of preferably 7 to 35 volume % and more preferably 8 to 30 volume %.

A film thickness of the resistor layer may be thin, but is normally 1 μm or more, and preferably 10 to 15 μm or so.

Production Method of Resistor

Next, a production method of the resistor will be explained as an example.

(1) First, a resistor paste is prepared.

Resistor Paste

A resistor paste includes the above glass material substantially not containing lead but containing CaO and B₂O₃, the above conductive material substantially not containing lead, and an organic vehicle.

The organic vehicle is obtained by dissolving a binder in an organic solvent. The binder used in the organic vehicle is not particularly limited, and may be suitably selected from a variety of normal binders, such as ethyl cellulose and polyvinyl butyral.

Also, the organic solvent to be used is not particularly limited, and may be suitably selected from a variety of organic solvents, such as terpineol, butyl carbitol, acetone and toluene.

A content of the glass material in the paste is preferably 65 to 93 volume % and more preferably 68 to 90 volume % when assuming that volume of the powder is 100.

A content of the conductive material in the paste is preferably 7 to 35 volume % and more preferably 8 to 30 volume % when assuming that volume of the powder is 100.

Note that additives may be included in the paste other than the above components.

As the additives, CuO, oxides having the perovskite type crystal structure (crystal structure expressed by ABX₃), ZnO and MgO, etc. may be mentioned.

CuO serves as a temperature characteristic (TCR) adjustor of a resistance value. A content of CuO in this case is preferably 0.1 to 2 volume %, and more preferably 0.5 to 2 volume %. When the adding quantity of CuO increases, the STOL tends to deteriorate.

As oxides having the perovskite type crystal structure, simple perovskite, such as CaTiO₃, SrTiO₃, BaTiO₃, CaZrO₃ and SrZrO₃, defective perovskite and composite perovskite, etc. may be mentioned. Among these, at least any one of CaTiO₃, SrTiO₃ and BaTiO₃ is preferably used, and more preferably, BaTiO₃ is used. Oxides having the perovskite type crystal structure have effects of adjusting balance of the TCR and STOL. A content of an oxide having the perovskite type crystal structure is preferably 0.1 to 12 volume %, and more preferably 1 to 10 volume %.

ZnO serves as a TCR adjustor. A content of ZnO in this case is preferably 0.1 to 5 volume %, and more preferably 1 to 4 volume %. When an adding quantity of ZnO increases, the STOL tends to get worse.

MgO serves as a TCR adjuster. A content of MgO in this case is preferably 1 to 8 volume % and more preferably 2 to 6 volume %. When an adding quantity of MgO increases, the STOL tends to get worse.

As other additives serving as a TCR adjustor, for example, MnO₂, V₂O₅, TiO₂, Y₂O₃, Nb₂O₅, Cr₂O₃, Fe₂O₃, CoO, Al₂O₃, ZrO₂, SnO₂, HfO₂, WO₃ and Bi₂O₃, etc. may be mentioned.

The resistor paste is produced by adding an organic vehicle to a conductive material, a glass material and a variety of additives to be blended in accordance with need, and kneading, for example, with a three-roll mill.

In this case, a ratio (W2/W1) of total weight (W1) of the glass material, conductive material and respective powders of additives to be added in accordance with need and weight of the organic vehicle (W2) is preferably 0.25 to 4, and more preferably 0.5 to 2.

(2) Next, the above resistor paste is formed on a substrate, for example, by a screen printing method, etc., dried, and fired at a predetermined firing temperature for a predetermined time to produce a resistor.

In the present invention, a preferable firing condition is a firing temperature at 830 to 870° C., preferably 840 to 860° C., and the firing temperature holding time is 5 to 15 minutes, preferably 8 to 12 minutes. When observing a section along the thickness direction of the resistor layer with a transmission electron microscope (TEM), an occupying area of the crystal substance CaB₂O₄ precipitated in a resistor layer on the observation section can be made less than 30.0% of on area of the resistor layer of the observation section by the burning under such conditions. When the occupying area of the crystal substance CaB₂O₄ is less than 30.0%, it is possible to provide a lead-free resistor having a small STOL of, for example, ±7% or less, preferably less than ±5% while having a high resistance value of, for example, 100 kΩ/□ or more, and preferably 1MΩ/□ or more.

The produced resistor can be applied to an electrode portion of a capacitor and inductor, etc. other than a single-layer or multilayer circuit substrate as an electronic device.

Electronic Device

An electronic device according to the present invention is not particularly limited, and a circuit substrate, a capacitor, an inductor, a chip resistor and isolator, etc. may be mentioned.

### EXAMPLES

Next, the present invention will be explained further in detail by specific examples of the embodiment of the present invention. Note that the present invention is not limited to the examples.

Production of Resistor Paste

A conductive material was produced as below. Predetermined amounts of CaCO₃ or Ca(OH)₂ powder and RuO₂ powder were weighed to be a composition of CaRuO₃, mixed by a ball mill and dried. The obtained powder was heated to 1400° C. at a rate of 5° C./min., kept at the temperature for 5 hours, then, cooled to the room temperature at a rate of 5° C./min. Thus obtained CaRuO₃ was grinded by a ball mill and CaRuO₃ powder was obtained. The obtained powder was confirmed to have a single phase of a desired compound by an XRD.

A glass material was produced as below. Predetermined amounts of CaCO₃, B₂O₃, SiO₂, ZrO₂, SrO, CuO and NiO were weighed to be final compositions (10 kinds) shown in Table 1, mixed by a ball mill and dried. The obtained powder was heated to 1300° C. at a rate of 5° C./min., kept at the temperature for 1 hour, then, abruptly cooled by being dropped in water to be vitrified. The obtained vitrification was grinded by a ball mill and glass powder was obtained. The obtained glass powder was confirmed to be amorphous by an XRD.

TABLE 1

| Glass No. | Composition Ratio |
|---|---|
| \mathring{1} | CaO:B₂O₃:SiO₂:ZrO₂ = 35:42:18:5 (mol %) |
| \mathring{2} | CaO:B₂O₃:SiO₂:ZrO₂ = 35:36:24:5 (mol %) |
| \mathring{3} | CaO:B₂O₃:SiO₂:ZrO₂ = 35:30:30:5 (mol %) |
| \mathring{4} | CaO:B₂O₃:SiO₂:ZrO₂ = 35:27:33:5 (mol %) |
| \mathring{5} | CaO:B₂O₃:SiO₂ = 38:29:33 (mol %) |
| \mathring{6} | CaO:B₂O₃:SiO₂:SrO = 29:25:36:10 (mol %) |
| \mathring{7} | CaO:B₂O₃:SiO₂:ZrO₂:CuO = 32:22:40:3:3 (mol %) |
| \mathring{8} | CaO:B₂O₃:SiO₂:ZrO₂:NiO = 35:36:24:4.9:0.1 (mol %) |
| \mathring{9} | CaO:B₂O₃:SiO₂:ZrO₂:NiO = 35:36:24:4:1 (mol %) |
| \mathring{10} | CaO:B₂O₃:SiO₂:ZrO₂:NiO = 31:32:24:3:10 (mol %) |

An organic vehicle was produced as below. Terpineol as a solvent was heated while agitated, ethyl cellulose as a resin is dissolved therein to produce an organic vehicle.

The produced conductive material powder and glass powder were weighed to be compositions shown in Table 2, an organic vehicle was added thereto and kneaded by a three-roll mill to obtain a resistor paste. A weight ratio of total weight of the conductive powder and glass material powder and weight of an organic vehicle was suitably adjusted to be in a range of 1:0.25 to 1:4 and made to be a paste, so that an obtained paste has suitable viscosity for screen printing.

Production of Thick Film Resistor

An Ag—Pt conductor paste was printed to be a predetermined shape on a 96% alumina substrate by screen printing and dried. Ag was 95 wt % and Pt was 5 weight % in the Ag—Pt conductor paste. The alumina substrate was put in a belt furnace by a pattern of one hour from feeding to discharging, so that the conductor was burnt on the substrate. The firing temperature was 850° C. and a holding time of the temperature was 10 minutes. The resistor paste produced as explained above was screen printed to be a predetermined shape (1×1 mm) on the alumina substrate formed with the conductor, and dried. Then, the resistor paste was burnt under the same condition as burning of the conductor, so that a thick membrane resistor was obtained. The thickness of the resistor was 12 μm. Samples obtained by changing the burning temperature (firing temperature) were produced.

Evaluation of Thick Membrane Resistor Characteristics

Characteristics evaluations of a resistance value, STOL, crystal substance occupying area (crystal substance area %) and changes over time were performed on the obtained thick film resistors.

A resistance value was measured by using a multimeter 34401A made by Agilent Technologies. The results are shown in Table 2. In Table 2, average values of 36 samples are shown. In the present example, “a resistor value >100kΩ” was used as a reference of the characteristics.

Evaluation on the STOL (short time overload) was made by applying a test voltage to a thick membrane resistor for 5 seconds, letting stand for 30 minutes, and confirming a change rate of the resistance value before and after that. The test voltage was 2.5 times as much as a rated voltage. The rated voltage was √(R/8). Here, R is a resistance value (Ω/□). Note that resistors having a resistance value by which a calculated test voltage thereof exceeds 200V were evaluated with a test voltage of 200V. The results are shown in Table 2. In Table 2, average values of 10 samples are shown. In the present example, “STOL<±5%” was used as a reference of the characteristics.

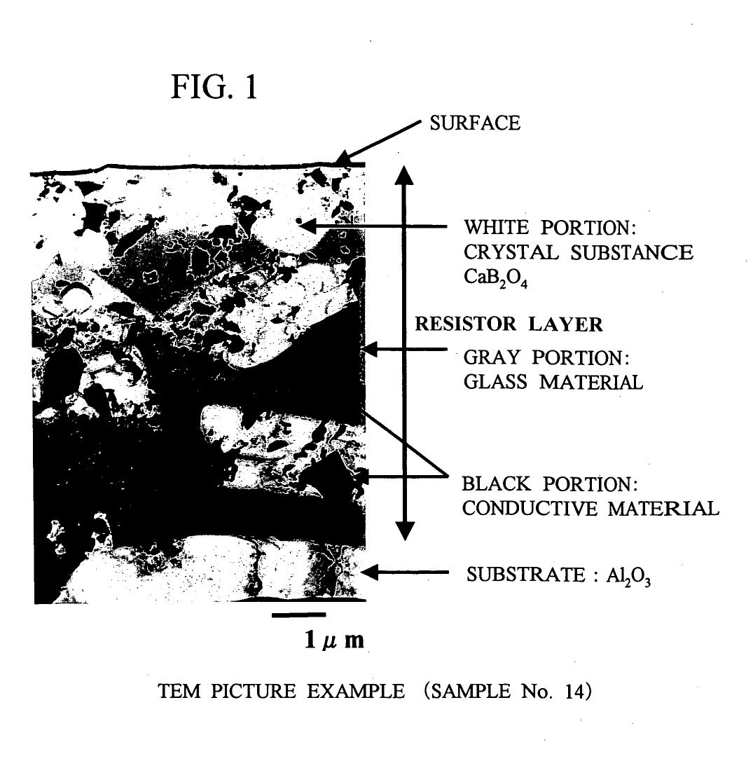

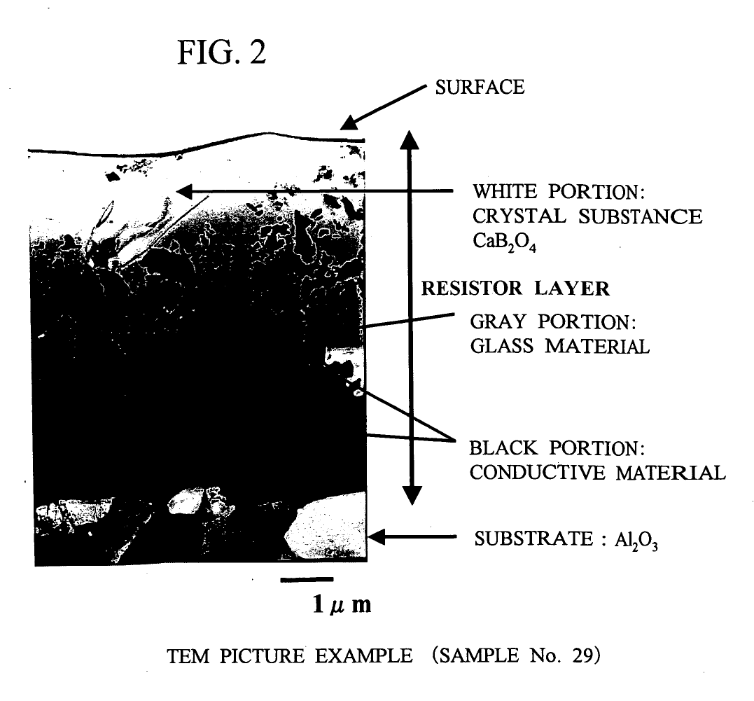

A crystal substance area percentage was evaluated by sampling a resistor burnt on an alumina substrate by FIB processing and observing the section with a TEM. A TEM picture of a section of a resistor (sample 14) is shown in FIG. 1. A TEM picture of a section of a resistor (sample 29) is shown in FIG. 2. By measuring a region of the crystal substance, the area percentage of the crystal substance was calculated. The results are shown in Table 2. In Table 2, average values of 5 samples are shown. There was unevenness of ±5% or so with respect to the average value in each sample.

Percentage of changes over time was evaluated by measuring a change rate of a resistance value when letting stand for 1000 hours at 85° C. and 85%RH. In Table 2, average values of 10 samples are shown. In the present example, “changes over time ≦±1.0%” was used as a reference of the characteristics.

TABLE 2

| | Conductive | | | | | | | Crystal | | | Change |
|---|---|---|---|---|---|---|---|---|---|---|---|
| Sample | Material | | Glass Material | | Firing | Holding | Crystal | Substance | Resistance | STOL | Over |
| No. | kind | volume % | kind | volume % | Temperature | Time | Substance | area % | value Ω | % | Time % |
| 1 | BaRuO₃ | 21 | \mathring{1} | 79 | 850 | 10 | CaB₂O₄ | 37.00% | 1109000 | −10.5 | 4.1 |
| 2 | BaRuO₃ | 20 | \mathring{2} | 80 | 850 | 10 | CaB₂O₄ | 23.00% | 1477000 | −1.2 | 0.9 |
| 3 | BaRuO₃ | 22 | \mathring{3} | 78 | 850 | 10 | CaB₂O₄ | 12.20% | 1278000 | −1 | 0.9 |
| 4 | BaRuO₃ | 22 | \mathring{4} | 78 | 850 | 10 | CaB₂O₄ | 7.60% | 1332000 | −0.8 | 0.8 |
| 5 | SrRuO₃ | 15 | \mathring{1} | 85 | 850 | 10 | CaB₂O₄ | 36.20% | 1013000 | −12.7 | 3.6 |
| 6 | SrRuO₃ | 16 | \mathring{2} | 84 | 850 | 10 | CaB₂O₄ | 29.70% | 1086000 | −1.9 | 0.9 |
| 7 | SrRuO₃ | 15 | \mathring{3} | 85 | 850 | 10 | CaB₂O₄ | 14.80% | 1520000 | −0.75 | 0.7 |
| 8 | SrRuO₃ | 15 | \mathring{4} | 85 | 850 | 10 | CaB₂O₄ | 9.70% | 1642000 | −0.45 | 0.7 |
| 9 | RuO₂ | 7 | \mathring{1} | 93 | 850 | 10 | CaB₂O₄ | 42.00% | 1190000 | −16.6 | 2.2 |
| 10 | RuO₂ | 8 | \mathring{2} | 92 | 850 | 10 | CaB₂O₄ | 35.20% | 1650000 | −3.7 | 0.9 |
| 11 | RuO₂ | 9 | \mathring{3} | 91 | 850 | 10 | CaB₂O₄ | 28.50% | 1018000 | −1.5 | 0.8 |
| 12 | RuO₂ | 9 | \mathring{4} | 91 | 850 | 10 | CaB₂O₄ | 19.30% | 1160000 | −1.2 | 0.6 |
| 13 | CaRuO₃ | 15 | \mathring{1} | 85 | 850 | 10 | CaB₂O₄ | 35.00% | 1013000 | −8.7 | 3.3 |
| 14 | CaRuO₃ | 15 | \mathring{2} | 85 | 850 | 10 | CaB₂O₄ | 29.30% | 1354000 | −1.6 | 0.8 |
| 15 | CaRuO₃ | 14 | \mathring{3} | 86 | 850 | 10 | CaB₂O₄ | 14.20% | 1468000 | −0.5 | 0.6 |
| 16 | CaRuO₃ | 15 | \mathring{4} | 85 | 850 | 10 | CaB₂O₄ | 8.50% | 1300000 | −0.2 | 0.5 |
| 17 | CaRuO₃ | 14 | \mathring{5} | 86 | 850 | 10 | CaB₂O₄ | 25.10% | 2270000 | −1.4 | 0.8 |
| 18 | CaRuO₃ | 15 | \mathring{6} | 85 | 850 | 10 | CaB₂O₄ | 27.30% | 1270000 | −1.3 | 0.8 |
| 19 | CaRuO₃ | 14 | \mathring{7} | 86 | 850 | 10 | CaB₂O₄ | 11.50% | 1050000 | −0.42 | 0.5 |
| 20 | CaRuO₃ | 13 | \mathring{2} | 87 | 800 | 10 | CaB₂O₄ | 21.10% | 2517000 | −22.3 | 3.1 |
| 21 | CaRuO₃ | 15 | \mathring{2} | 85 | 830 | 10 | CaB₂O₄ | 23.60% | 1750000 | −1.9 | 0.7 |
| 22 | CaRuO₃ | 14 | \mathring{2} | 86 | 870 | 10 | CaB₂O₄ | 29.50% | 1292000 | −1.1 | 0.9 |
| 23 | CaRuO₃ | 9 | \mathring{2} | 91 | 900 | 10 | CaB₂O₄ | 34.30% | 1013000 | −3 | 1.5 |
| 24 | CaRuO₃ | 15 | \mathring{2} | 85 | 850 | 0 | CaB₂O₄ | 27.60% | 1420000 | −1.9 | 2.6 |
| 25 | CaRuO₃ | 15 | \mathring{2} | 85 | 850 | 5 | CaB₂O₄ | 28.50% | 1390000 | −1.6 | 0.8 |
| 26 | CaRuO₃ | 15 | \mathring{2} | 85 | 850 | 15 | CaB₂O₄ | 29.80% | 1310000 | −1.7 | 0.7 |
| 27 | CaRuO₃ | 15 | \mathring{2} | 85 | 850 | 20 | CaB₂O₄ | 31.20% | 1280000 | −2.5 | 1 |
| 28 | CaRuO₃ | 15 | \mathring{8} | 85 | 850 | 10 | CaB₂O₄ | 15.90% | 1297000 | −0.98 | 0.7 |
| 29 | CaRuO₃ | 15 | \mathring{9} | 85 | 850 | 10 | CaB₂O₄ | 8.10% | 1084000 | −0.17 | 0.3 |
| 30 | CaRuO₃ | 13 | \mathring{10} | 87 | 850 | 10 | CaB₂O₄ | 9.80% | 1541000 | −0.5 | 0.5 |

As shown in Table 2, in samples 1 to 19, it was confirmed that the STOL becomes preferable when an average occupying area of the crystal substance CaB₂O₄ in each conductive material is less than 30.0% of an area of the resistor layer of its observation section.

In samples 20 to 23, when changing the firing temperature, the higher the temperature, the larger the crystal substance area becomes, and the STOL gets worse at 900° C. However, when the firing temperature is 800° C., the crystal substance area is small but the STOL is unfavorable. It is because the resistor is not sufficiently sintered. It was confirmed that when using CaO—B₂O₃—SiO₂ based glass, it was necessary to burn at approximately 830° C. or more and preferably at 830° C. to 870° C.

In samples 24 to 27, when changing the holding time of the firing temperature, the longer the holding time is, the larger the crystal substance area becomes, and the STOL gets worse with 20 minutes. The crystal substance area does not change much comparing with that in the case of changing the firing temperature. It was confirmed that 5 to 15 minutes or so was preferable.

In samples 28 to 30, by using a glass material containing NiO, it was confirmed that an occupying area of the crystal substance CaB₂O₄ precipitated in the resistor layer was suppressed, the TCR and STOL were balanced and, moreover, changes over time were suppressed comparing with those in samples 13 to 16 wherein substantially the same quantity of glass material not containing NiO is used, and conditions of a kind and quantity of a conductive material, a firing temperature and firing holding time are approximately the same.

Note that samples 1, 5, 9, 10, 13, 20, 23 and 27 are comparative examples, and the rest are examples.

The embodiments of the present invention were explained above, but the present invention is not at all limited to the embodiments, and may be variously modified within a scope of the present invention.

1. A resistor, having a resistor layer including a glass material substantially not containing lead but containing CaO and B₂O₃ and a conductive material substantially not containing lead, wherein:
when observing a section along the thickness direction of said resistor layer with a transmission electron microscope (TEM), an occupying area of a crystal substance CaB₂O₄ precipitated in a resistor layer of said observation section is less than 30.0% of the resistor layer of said observation section.

2. A resistor having a resistor layer on a substrate,
obtained by forming a resistor paste including a glass material substantially not containing lead but containing CaO and B₂O₃, a conductive material substantially not containing lead, and an organic vehicle, then, firing at 830 to 870° C. for 5 to 15 minutes; and
when observing a section along the thickness direction of said resistor layer with a transmission electron microscope (TEM), an occupying area of a crystal substance CaB₂O₄ precipitated in a resistor layer of said observation section is less than 30.0% of an area of the resistor layer of said observation section.

3. The resistor as set forth in claim 1, wherein said glass material includes an A group containing CaO, a B group containing B₂O₃, and a C group containing SiO₂; and contents of the respective groups are A group: 25 to 40 mol %, B group: 20 to 40 mol %, and C group: 20 to 40 mol %.

4. The resistor as set froth in claim 1 wherein said glass material includes an A group containing CaO, a B group containing B₂O₃, a C group containing SiO₂, a D group containing at least one kind of ZrO₂, SrO and CuO, and an E group containing NiO; and contents of the respective groups are A group: 25 to 40 mol %, B group: 20 to 40 mol %, C group: 20 to 40 mol %, D group: 0 to 10 mol % (excluding 0 mol %), and E group: 0.1 to 10 mol %.

5. The resistor as set forth in claim 1, wherein said conductive material contains at least one selected from BaRuO₃, SrRuO₃, RuO₂ and CaRuO₃.

6. The resistor as set froth in claim 1, wherein said resistor layer includes 65 to 93 volume % of said glass material and 7 to 35 volume % of said conductive material.

7. An electronic device having a resistor as set forth in claim 1.

8. The resistor as set forth in claim 2, wherein said glass material includes an A group containing CaO, a B group containing B₂O₃, and a C group containing SiO₂; and contents of the respective groups are A group: 25 to 40 mol %, B group: 20 to 40 mol %, and C group: 20 to 40 mol %.

9. The resistor as set froth in claim 2, wherein said glass material includes an A group containing CaO, a B group containing B₂O₃, a C group containing SiO₂, a D group containing at least one kind of ZrO₂, SrO and CuO, and an E group containing NiO; and contents of the respective groups are A group: 25 to 40 mol %, B group: 20 to 40 mol %, C group: 20 to 40 mol %, D group: 0 to 10 mol % (excluding 0 mol %), and E group: 0.1 to 10 mol %.

10. The resistor as set forth in claim 2, wherein said conductive material contains at least one selected from BaRuO₃, SrRuO₃, RuO₂ and CaRuO₃.

11. The resistor as set froth in claim 2, wherein said resistor layer includes 65 to 93 volume % of said glass material and 7 to 35 volume % of said conductive material.

12. An electronic device having a resistor as set forth in claim 2.
